(19) United States
(12) Patent Application Publication
(10) Pub. No.: US 2008/0250354 A1
(43) Pub. Date: Oct. 9, 2008

(54) MULTIPLE ITEM SELECTION METHOD FOR A MOBILE TERMINAL

(75) Inventor: Won Joo PARK, Gwacheon-si (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/051,416

(22) Filed: Mar. 19, 2008

(30) Foreign Application Priority Data
Apr. 3, 2007 (KR) 2007-0032791

(51) Int. Cl. G06F 3/048

(52) U.S. Cl. 715/845

(57) ABSTRACT

An enhanced multiple item selection method for a mobile terminal is provided. The enhanced multiple item selection method enables selecting multiple data items by effectively selecting corresponding data items listed of a data item list. The multiple item selection method of the present invention includes displaying a data item list comprising a plurality of data items, marking, if a multiple item selection mode command is detected, a selection marker on a data item on which a cursor is located, and selecting multiple data items by navigating the cursor across two or more of the plurality of data items of the data item list.

### PRIORITY

This application claims the benefit under 35 U.S.C. § 119(a) of a Korean patent application filed in the Korean Intellectual Property Office on Apr. 3, 2007 and assigned Serial No. 2007-0032791, the entire disclosure of which is hereby incorporated by reference.

### BACKGROUND OF THE INVENTION

1. Field of the Invention

The present invention relates to a mobile terminal. More particularly, the present invention relates to an enhanced multiple item selection method for a mobile terminal that is capable of selecting multiple data items by selecting the data items from a list of data items.

2. Description of the Related Art

As mobile devices become more sophisticated, they are increasingly being used to store large amount and various kinds of data (such as text, audio, video, communication list, phonebook, etc.). For this reason, advanced data management techniques have been proposed for efficiently dealing with the data. Such data management techniques allow multiple data items to be processed by a single command. For example, multiple text messages can be selected to be deleted, multiple music files or video files can be selected to be sequentially played, multiple recent items of history can be selected to be erased, or multiple data items can be selected to be moved to another folder.

However, conventional data management techniques have a drawback in that candidate items to be processed simultaneously are selected by first selecting all items and then deselecting the items that are not supposed to be selected, thereby increasing manipulation complexity and inconvenience for a user.

### SUMMARY OF THE INVENTION

An aspect of the present invention is to address at least the above mentioned problems and/or disadvantages and to provide at least the advantages described below. Accordingly, an aspect of the present invention is to provide an enhanced multiple item selection method for a mobile terminal that is capable of effectively selecting multiple data items that are to be simultaneously or sequentially executed.

Also, an aspect of the present invention is to provide an enhanced multiple item selection method for a mobile terminal that is capable of reducing manipulation complexity when selecting multiple data items.

In accordance with an aspect of the present invention, a multiple item selection method for a mobile terminal is provided. The method includes displaying a data item list comprising a plurality of data items, marking, if a multiple item selection mode command is detected, a selection marker on a data item on which a cursor is located, and selecting multiple data items by navigating the cursor across two or more of the plurality of data items of the data item list.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following detailed description in conjunction with the accompanying drawings, in which:

FIG. 1 is a block diagram illustrating a configuration of a mobile terminal that adopts a multiple item selection method according to an exemplary embodiment of the present invention;

FIG. 2 is a flowchart illustrating a multiple item selection method according to an exemplary embodiment of the present invention;

FIG. 3 is a flowchart illustrating a multiple item selection procedure of the multiple item selection method of FIG. 2; and

FIGS. 4A to 4F are screen images illustrating steps of the multiple item selection method of FIG. 2.

Throughout the drawings, like reference numerals will be understood to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The following description is directed to a multiple item selection method for use with a mobile terminal according to exemplary embodiments of the present invention. The mobile terminal may be any of various types of mobile phones including a cellular phone, Personal Digital Assistants (PDAs), Smartphones, and their equivalents having wireless communication and information processing capabilities.

Hereafter, the multiple item selection method is described in association with MPEG Audio Layer 3 (MP3) files. However, the exemplary embodiments of the present invention are not limited thereto. For example, the multiple item selection method may be applied to all types of data management in which data items are managed in the form of a list.

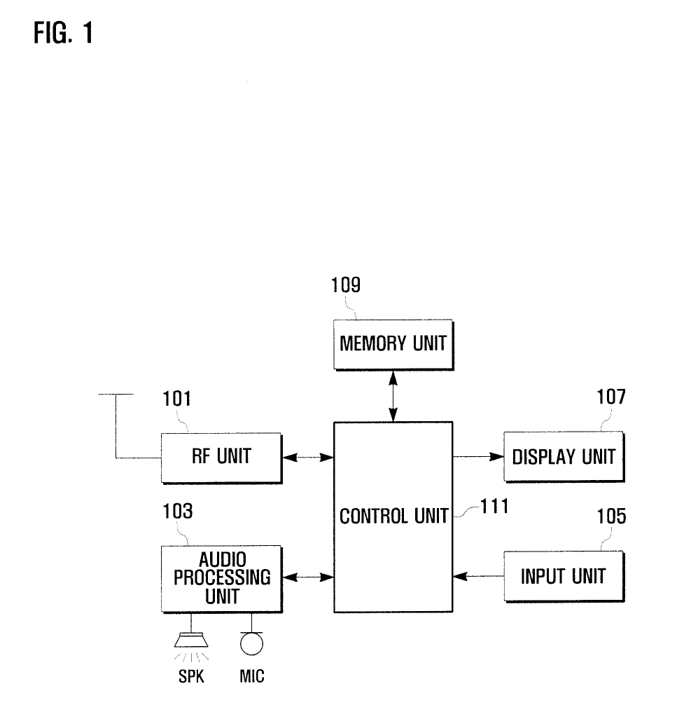

FIG. 1 is a block diagram illustrating a configuration of a mobile terminal that adopts a multiple item selection method according to an exemplary embodiment of the present invention.

Referring to FIG. 1, the mobile terminal includes a radio frequency (RF) unit 101, an audio processing unit 103, an input unit 105, a display unit 107, a memory unit 109, and a control unit 111.

The RF unit 101 is responsible for communicating radio signals to and from a mobile communication network. For example, the RF unit 101 establishes radio channels to the mobile communication network for communicating voice, data, text messages and multimedia messages. Alternatively, RF unit 101 or an additional RF unit may be used to communicate with one or more mobile terminals either directly or via one or more relays.

The audio processing unit 103 converts an analog audio signal input through a microphone (MIC) into a digital audio signal and transfers the digital audio signal to the control unit 111. The audio processing unit 103 also converts a digital audio signal generated by the control unit 111 into an analog audio signal and outputs the analog audio signal through a speaker (SPK) in the form of an audible sound wave.

The input unit 105 is provided with a keypad. The input unit 105 may also be provided with at least one of a touch screen, touchpad, scroll wheel and the like. The input unit 105 outputs a key signal to the control unit 111 in response to a key input from the keypad.

The input unit 105 is configured so as to generate a key sequence for moving a cursor across data items on a data item list, selecting a data item from the data item list, and executing a processing command.

The display unit 107 displays various application screens with operational status information and stored information, under the control of the control unit 111. The display unit 107 can be implemented with a Liquid Crystal Display (LCD) or an Organic Light Emitting Diodes (OLED). In an exemplary embodiment, the display unit 107 and input unit 105 are coupled together so as to embody a touch screen.

The display unit 107 displays the data item list and at least one cursor navigating across data items of the data item list. If a data item is selected, a selection mark appears on the selected data item.

The memory unit 109 stores application programs for executing functions supported by the mobile terminal and application related information such as application parameters and menu settings.

The memory unit 109 also stores data represented by the data items on the data item list and a multiple item selection application which enables selecting multiple items from the data item list. The memory unit 109 also stores an application program together with a threshold value to be compared with a time corresponding to a duration of an input of a selection key input.

The control unit 111 controls the general operations of the mobile terminal. In particular, the control unit 111 is provided with a transmission section for performing encoding and modulation of a transmission signal and a reception section for performing demodulation and decoding of a received signal. The control unit 111 may incorporate a modem and a codec.

In more detail, the control unit 111 controls the display unit 107 to display a data item list and enters a multiple item selection mode in response to a mode selection command. At this time, the control unit 111 records a duration of the input of the mode selection command and compares the duration to a threshold value stored within the memory unit 109.

The control unit 111 controls the display unit 107 to display an animation indicating that the multiple item selection mode is activated. The animation can be provided in the form of a blinking selection marker, size-changing selection marker, color-changing selection marker or any other type of indication.

If a navigation command is detected on a navigation key of the input unit 105 when in the multiple item selection mode, the control unit 111 moves the cursor onto another data item in the data item list.

The control unit 111 then determines whether a selection marker is marked for the data item on which the cursor is newly located. If the selection marker is marked, the control unit 111 unmarks the selection marker on the data item. If a selection marker is not marked, the control unit 111 marks a selection marker on the data item.

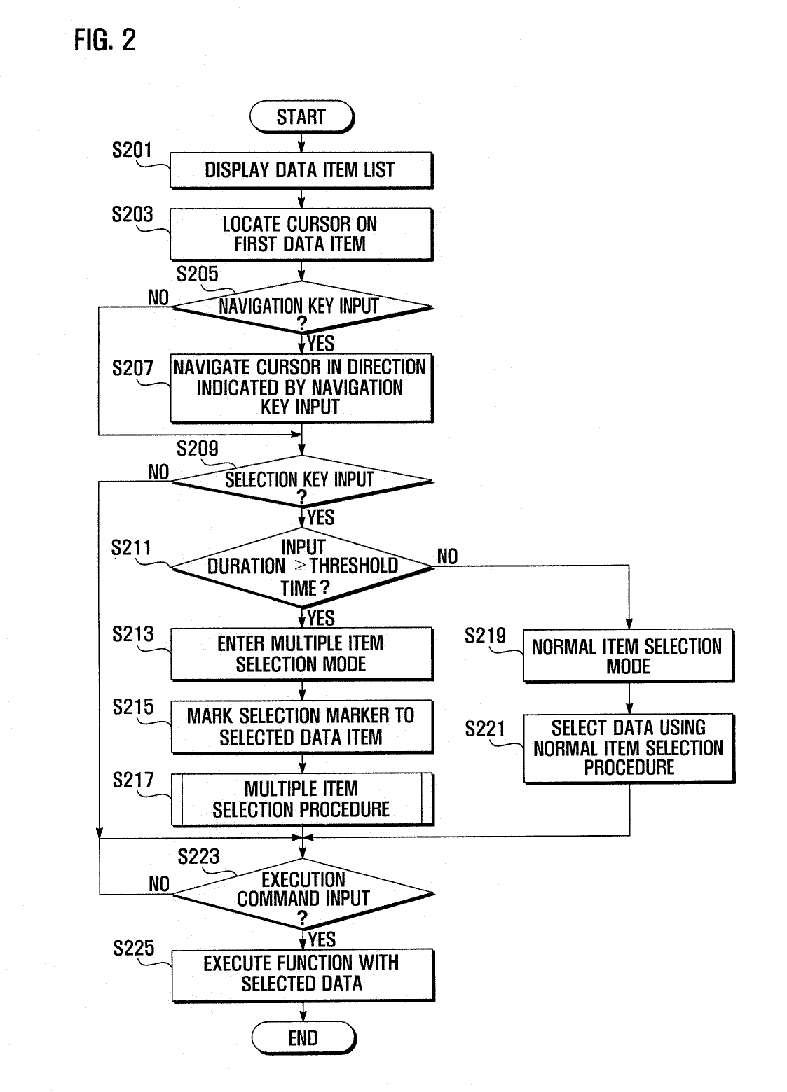

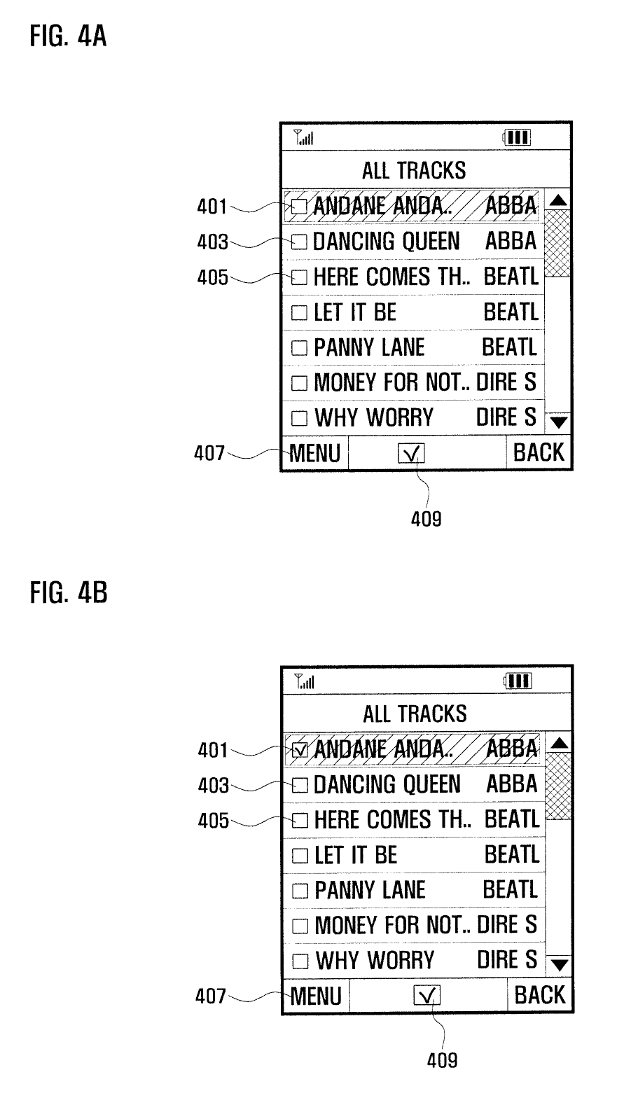

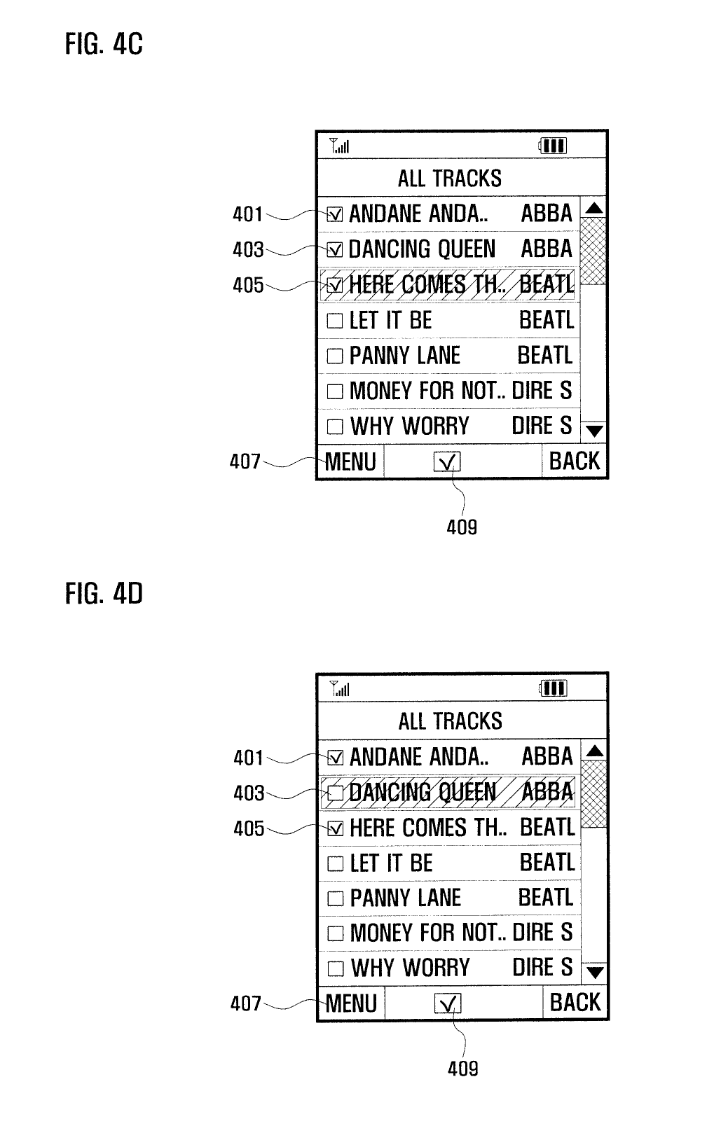

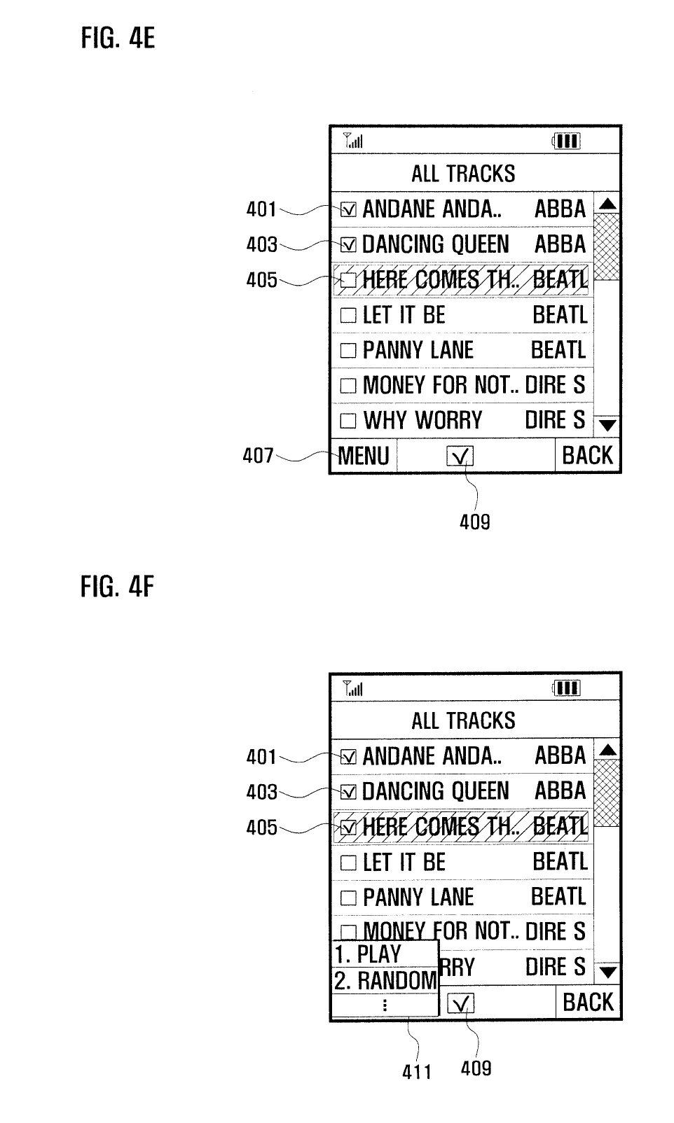

FIG. 2 is a flowchart illustrating a multiple item selection method according to an exemplary embodiment of the present invention, and FIGS. 4A to 4F are screen images illustrating steps of the multiple item selection method of FIG. 2.

Referring to FIGS. 2 and 4A to 4F, the control unit 111 controls the display unit 107 to display a data item list comprising data items (S201). Next, the control unit 111 locates the cursor on a first data item of the data item list (S203). The data items are provided with respective indicators and the first data item 401 of the data item list is distinguished from the other data items. The indicators may be implemented as check boxes or any other type of indication. Further, the indicators may be disposed at a certain location relative to each of the data items, such as the left side. The distinguishment of the data item may be implemented by the data item being inversely displayed by the cursor, as shown in FIG. 4A, or by any other type of distinguishment.

Next, the control unit 111 determines whether a key input is detected on a navigation key of the input unit 105 (S205). If a navigation key input is detected, the control unit 111 moves the cursor to the next data item corresponding to a direction of the navigation key (S207). If no navigation key input is detected, step S207 is skipped. Next, the control unit 111 determines whether a key input is detected on a selection key of the input unit 105 (S209). If a selection key input is detected, the control unit 111 determines whether a duration of the selection key input is longer than or equal to a threshold time (S211). The duration of the selection key input is a duration of time in which the selection key is pressed. The threshold time may be preset from 2 to 4 seconds.

If the selection key input duration is shorter than the threshold time, the control unit 111 activates a normal item selection mode (S219) and selects the data item (S221). In the normal item selection mode, the data selection is performed consistent with the conventional data selection procedure.

If the duration of the selection key is longer than or equal to the threshold time, the control unit 111 activates a multiple item selection mode (S213) and marks the data item with a selection marker as shown in FIG. 4B (S215).

FIG. 4B shows an example in which the first data item 401 is selected so as to be marked by the selection marker. The selection marker can be presented in the form of an animation marker such as blinking marker, size-changing marker, color changing marker, or the like.

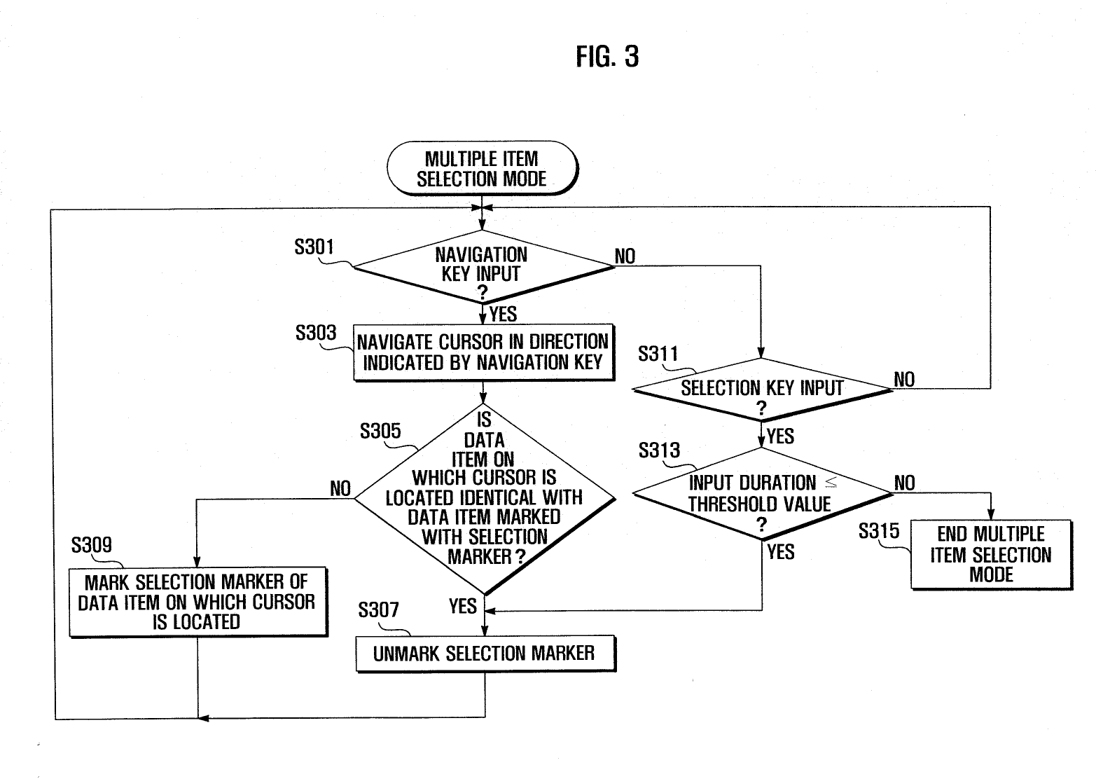

Once the multiple item selection mode is activated, the control unit 111 performs a multiple item selection procedure (S217). The multiple item selection procedure is described later in more detail with reference to FIG. 3.

After all candidate data items are selected at step S217 or S221, the control unit 111 determines whether the input of execution command is detected on an execution key of the input unit 105 (S223). If the input of an execution command has been detected, the control unit 111 executes a function using the data represented by the selected data items (S225). The execution command can be any of delete, copy, sequential play command or any other execution command, depending on the current operational mode of the mobile terminal. FIGS. 4A to 4F show an example of a multiple data item selection procedure for generating and playing a list of candidate music files while the mobile terminal operates in a music player mode. In this case, if a menu button 407 is selected after multiple songs have been selected from a song list (see FIGS. 4A to 4E), the control unit 111 controls the display unit to present menu options 411 for playing the selected songs as shown in FIG. 4F. The menu options can be configured to be automatically presented after the song selection is completed. Here, the execution command can be generated by selecting one of the menu options “PLAY” and “RANDOM”.

FIG. 3 is a flowchart illustrating a multiple item selection procedure of the multiple item selection method of FIG. 2.

Referring to FIG. 3, after the multiple item selection mode is activated, the control unit 111 determines whether an input on a navigation key of the input unit 105 is detected (S301) while a selection marker is marked on a data item as shown in FIG. 4B. If an input on the navigation key is detected, the control unit 111 moves the cursor to a next data item in a direction corresponding to the navigation key (S303) and determines whether the data item on which the cursor is located is identical with the data item marked with the selection marker (S305).

If the data item on which the cursor is located is identical with the data item marked with the selection marker, the control unit 111 unmarks the selection mark on the data item on which the cursor is located (S307). However, if the data item on which the cursor is located is not identical with the data item marked with the selection marker the control unit 111 marks the selection marker of the data item on which the cursor is located (S309).

After step S307, the control unit 111 repeats step S301 in order to select another data item. In an example of FIG. 4C, the data items 401, 403, and 405 are marked with the selection markers and the cursor is located on the data item 405. If the cursor is moved onto the data item 403, the selection marker of the data item 403 disappears as shown in FIG. 4D.

Identically, after step S309, the control unit 111 repeats step S301 in order to select multiple data items. In an example of FIG. 4B, the data item 401 is marked with the selection marker. According to the navigation of the cursor on to the data items 403 and 405, the selection marker is marked to the data items 403 and 405 as shown if FIG. 4C.

If no navigation key input is detected at step S301, the control unit 111 determines whether a selection key input is detected (S311). If a selection key input is not detected, the control unit 111 repeats step S301. If a selection key input is detected, the control unit 111 determines whether a duration of the selection key input is shorter than or equal to a threshold time (S313).

If the duration of the selection key input is shorter than or equal to the threshold time, the control unit 111 unmarks the selection marker from the data item on which the cursor is located (S307). Next, the control unit 111 repeats step S301.

For example, if a selection key input is detected with a duration that is shorter than or equal to the threshold time, while the data items 401, 403, and 405 are marked with the selection markers and the cursor is located on the data item 405 as shown in FIG. 4C, the control unit 111 unmarks the selection marker of the data item 405 as shown in FIG. 4E. The selection marker can be presented in the form of an animation.

If the duration selection key input is greater than the threshold time at step S313, the control unit 111 ends the multiple item selection mode (S315). For example, if the selection key input is detected with a duration longer than the threshold time, while the multiple data items are marked with the selection markers as shown in FIG. 4D, the control unit 111 ends the multiple item selection mode. If the multiple item selection mode ends, the animation of the selection marker disappears. The selection key input is generated by pushing a key mapped to the icon 409. After ending the multiple item selection mode, the control unit 111 returns FIG. 2 and then executes step S223.

Certain aspects of the present invention can also be embodied as computer readable code on a computer readable recording medium. A computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, code, and code segments for accomplishing the present invention can be easily construed by programmers skilled in the art to which the present invention pertains.

Although exemplary embodiments of the present invention have been described in detail hereinabove, it should be clearly understood by those skilled in the art that various changes in form and details may be made therein without departing from the spirit and scope of the present invention, as defined by the appended claims and their equivalents.

As described above, the multiple item selection method of the exemplary embodiments of the present invention enable the selection of multiple items to be executed simultaneously or sequentially.

Also, the multiple item selection method of the exemplary embodiments of the present invention is advantageous in that they result in the reduction of manipulation complexity when selecting multiple data items by reducing a number of key inputs.

What is claimed is:

1. A multiple item selection method for a mobile terminal, comprising:
displaying a data item list comprising a plurality of data items;
marking, if a multiple item selection mode command is detected, a selection marker on a data item on which a cursor is located; and
selecting multiple data items by navigating the cursor across two or more of the plurality of data items of the data item list.

2. The multiple item selection method of claim 1, further comprising entering a multiple item selection mode in response to the multiple item selection mode command.

3. The multiple item selection method of claim 2, wherein the entering of the multiple item selection mode comprises:
determining whether a selection key input is detected on the data item on which the cursor is located;
determining, if the selection key input is detected on the data item, whether a duration of the selection key input is longer than a threshold time;
activating, if the duration of the selection key input is longer than the threshold time, the multiple item selection mode; and
marking the selection marker on a next data item on which the cursor moves in response to a navigation key input.

4. The multiple item selection method of claim 3, wherein the entering of the multiple item selection mode further comprises:
determining whether the navigation key input is detected before determining whether the selection key input is detected; and
moving, if the navigation key input is detected, the cursor to a next data item in a direction corresponding to the navigation key.

5. The multiple item selection method of claim 3, wherein the marking of the selection marker comprises:
determining whether the navigation key input is detected;
moving, if the navigation key input is detected, the cursor to a next data item in a direction corresponding to the navigation key;
determining whether the data item on which the cursor is located is identical with the data item marked with the selection marker; and
marking, if the data item on which the cursor is located is identical with the data item marked with the selection marker, the selection marker on the data item on which the cursor is located.

6. The multiple item selection method of claim 5, wherein the marking of the selection marker further comprises unmarking the selection marker if the data item on which the cursor is located is not identical with the data item marked with the selection marker.

7. The multiple item selection method of claim 6, wherein the marking of the selection marker further comprises:
determining, if the navigation key input is not detected, whether the selection key input is detected;
determining, if the selection key input is detected, whether the duration of the selection key input is shorter than the threshold time;
unmarking, if the duration of the selection key input is shorter than the threshold time, the selection marker on the data item on which the cursor is located; and
ending, if the duration of the selection key input time is not shorter than the threshold time, the multiple item selection mode.

8. The multiple item selection method of claim 6, wherein the selection marker is presented in the form of an animation.

9. The multiple item selection method of claim 3, further comprising determining, if no navigation key input is detected, whether the selection key input is detected on the data item on which the cursor is located.

10. The multiple item selection method of claim 9, further comprising:
activating, if the duration of the selection key input is shorter than the threshold time, a normal item selection mode; and
selecting the data items in the normal item selection mode.

11. At least one processor readable medium for storing a computer program of instructions configured to be readable by at least one processor for instructing the at least one processor to execute a computer process for performing a multiple item selection method for a mobile terminal, comprising instructions for:
displaying a data item list comprising a plurality of data items;
marking, if a multiple item selection mode command is detected, a selection marker on a data item on which a cursor is located; and
selecting multiple data items by navigating the cursor across two or more of the plurality of data items of the data item list.
